(19) United States
(12) Patent Application Publication
(10) Pub. No.: US 2020/0311455 A1
(43) Pub. Date: Oct. 1, 2020

(54) METHODS AND SYSTEMS FOR CORRECTING SENSOR INFORMATION

(71) Applicant: GM GLOBAL TECHNOLOGY OPERATIONS LLC, Detroit, MI (US)

(72) Inventors: Brent N. Bacchus, Sterling Heights, MI (US); Wei Tong, Troy, MI (US); Upali P. Mudalige, Oakland Township, MI (US)

(73) Assignee: GM GLOBAL TECHNOLOGY OPERATIONS LLC, Detroit, MI (US)

(21) Appl. No.: 16/366,927

(22) Filed: Mar. 27, 2019

(51) Int. Cl. G06K 9/32; G06K 9/00; G06T 7/73

(52) U.S. Cl. CPC G06K 9/3241; G06T 7/73; G06K 9/00805

(57) ABSTRACT

Methods and apparatus are provided for controlling a vehicle. In one embodiment, a method includes: receiving, by a processor, object detection data that indicates a plurality of objects detected in an environment of the vehicle; computing, by the processor, a correction value associated with at least one of range, roll, and pitch of the plurality of objects based on a likelihood function; applying, by the processor, the correction value to the object detection data to obtain corrected object detection data; and controlling, by the processor, the vehicle based on the corrected object detection data.

The technical field generally relates to sensors of vehicles, and more particularly relates to methods and systems for correcting information obtained from a sensor of a vehicle.

Autonomous and semi-autonomous vehicles make use of sensor information to control one or more components of the vehicle. Sensors such as radars, lidars, and cameras are disposed about the vehicle and sense observable conditions of the environment. In some instances, data obtained from the sensors can be inaccurate. For example, a detected range or a detected heading of an object may be inaccurate due to sensor limitations and/or uneven surface conditions.

Accordingly, it is desirable to provide methods and systems for correcting sensor information. Furthermore, other desirable features and characteristics of the present invention will become apparent from the subsequent detailed description and the appended claims, taken in conjunction with the accompanying drawings and the foregoing technical field and background.

### SUMMARY

Methods and apparatus are provided for controlling a vehicle. In one embodiment, a method includes: receiving, by a processor, object detection data that indicates a plurality of objects detected in an environment of the vehicle; computing, by the processor, a correction value associated with at least one of range, roll, and pitch of the plurality of objects based on a likelihood function; applying, by the processor, the correction value to the object detection data to obtain corrected object detection data; and controlling, by the processor, the vehicle based on the corrected object detection data.

In various embodiments, the method includes determining when the vehicle is at an intersection with cross traffic, and wherein the receiving, the computing, and the applying are performed when the vehicle is at the intersection.

In various embodiments, the method includes determining when the cross traffic exceeds a threshold, and wherein the receiving, the computing, and the applying are performed when the cross traffic exceeds the threshold.

In various embodiments, the computing the correction value is further based on an expectation maximization algorithm. In various embodiments, the computing the correction value comprises: evaluating the likelihood function on a grid for a give observation window; coarsely locating N largest local maximas from the grid; removing any maximas less than a threshold; merging nearby maximas; and applying the expectation maximization algorithm when there is one maxima remaining.

In various embodiments, the method includes when there are more than one maxima remaining, selecting a worst case. In various embodiments, the method includes when there are more than one maxima remaining, applying the expectation maximization algorithm to each coarse maxima and generating a hypotheses for each refined correction value with a probability given mixing a weight.

In various embodiments, the computing comprises computing the correction value for a window of data of the object detection data.

In various embodiments, the correction value is associated with range.

In various embodiments, the correction values is associated with pitch and roll.

In another embodiment, a system includes: at least one sensor that senses objects within an environment of the vehicle; and a controller configured to, by a processor, receive object detection data that indicates a plurality of objects detected in an environment of the vehicle, compute a correction value associated with at least one of range, roll, and pitch of the plurality of objects based on a likelihood function, apply the correction value to the object detection data to obtain corrected object detection data, and control the vehicle based on the corrected object detection data.

In various embodiments, the controller determines when the vehicle is at an intersection with cross traffic, and performs the receiving, the computing, and the applying when the vehicle is at the intersection.

In various embodiments, the controller determines when the cross traffic exceeds a threshold, and performs the receiving, the computing, and the applying when the cross traffic exceeds the threshold.

In various embodiments, the controller computes the correction value further based on an expectation maximization algorithm.

In various embodiments, the controller computes the correction value by: evaluating the likelihood function on a grid for a give observation window; coarsely locating N largest local maximas from the grid; removing any maximas less than a threshold; merging nearby maximas; and applying the expectation maximization algorithm when there is one maxima remaining.

In various embodiments, when there are more than one maxima remaining, the controller selects a worst case as the correction value. In various embodiments, when there are more than one maxima remaining, the controller applies the expectation maximization algorithm to each coarse maxima and generates a hypotheses for each refined correction value with a probability given mixing a weight for the correction value.

In various embodiments, the controller computes the correction value for a window of data of the object detection data.

In various embodiments, the correction value is associated with range.

In various embodiments, the correction values is associated with pitch and roll.

### BRIEF DESCRIPTION OF THE DRAWINGS

The exemplary embodiments will hereinafter be described in conjunction with the following drawing figures, wherein like numerals denote like elements, and wherein:

FIG. 1 is an illustration of a vehicle having a correction system in accordance with various embodiments;

FIG. 2 is a dataflow diagram illustrating the correction system in accordance with various embodiments;

FIG. 3 is an illustration of example data produced by the correction system in accordance with various embodiments; and

FIG. 4 is a flowchart illustrating a correction method that can be performed by the correction system in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning models, radar, lidar, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

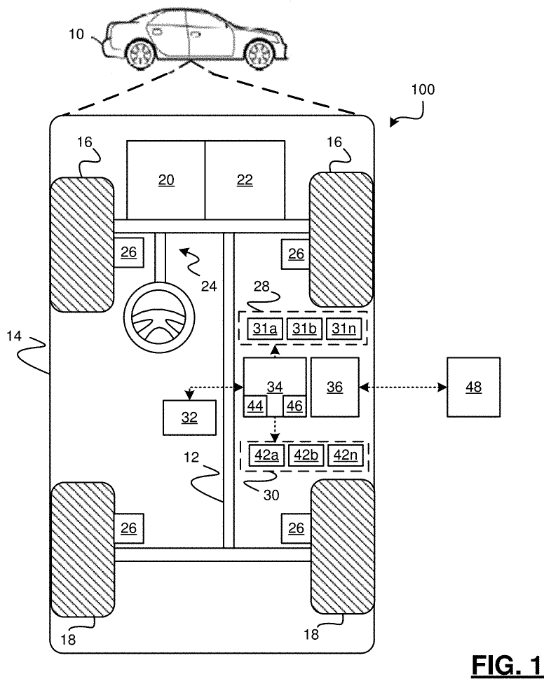

With reference to FIG. 1, a correction system shown generally as 100 is associated with a vehicle 10 in accordance with various embodiments. In general, the correction system (or simply “system”) 100 generates correction data including range and/or pitch/roll information for use in controlling the vehicle 10. In various embodiments, the correction system 100 generates the correction data based on information obtained from a sensor of the vehicle 10.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle or a semi-autonomous vehicle. As can be appreciated, the mapping system 100 can be implemented in other non-autonomous systems and is not limited to the present embodiments. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, etc., can also be used.

As shown, the vehicle 10 generally includes a propulsion system 20, a transmission system 22, a steering system 24, a brake system 26, a sensor system 28, an actuator system 30, at least one data storage device 32, at least one controller 34, and the communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

The steering system 24 influences a position of the vehicle wheels 16 and/or 18. While depicted as including a steering wheel for illustrative purposes, in some embodiments contemplated within the scope of the present disclosure, the steering system 24 may not include a steering wheel.

The sensor system 28 includes one or more sensing devices 31a-31n that sense observable conditions of the exterior environment and/or the interior environment of the vehicle 10. In various embodiments, the sensing devices 31a-31n include, but are not limited to, radars (e.g., long-range, medium-range-short range), lidars, global positioning systems, optical cameras (e.g., forward facing, 360-degree, rear-facing, side-facing, stereo, etc.), thermal (e.g., infrared) cameras, ultrasonic sensors, odometry sensors (e.g., encoders) and/or other sensors that might be utilized in connection with systems and methods in accordance with the present subject matter. The sensor system 28 provides information for determining the correction values used by the vehicle 10.

The actuator system 30 includes one or more actuator devices 42a-42n that control one or more vehicle features such as, but not limited to, the propulsion system 20, the transmission system 22, the steering system 24, and the brake system 26. In various embodiments, autonomous vehicle 10 may also include interior and/or exterior vehicle features not illustrated in FIG. 1, such as various doors, a trunk, and cabin features such as air, music, lighting, touch-screen display components (such as those used in connection with navigation systems), and the like.

The data storage device 32 stores data for use in automatically controlling the autonomous vehicle 10. In various embodiments, the data storage device 32 stores defined maps of the navigable environment. In various embodiments, the defined maps are generated by the mapping system 100 and include static and dynamic lane level information as will be discussed in more detail below.

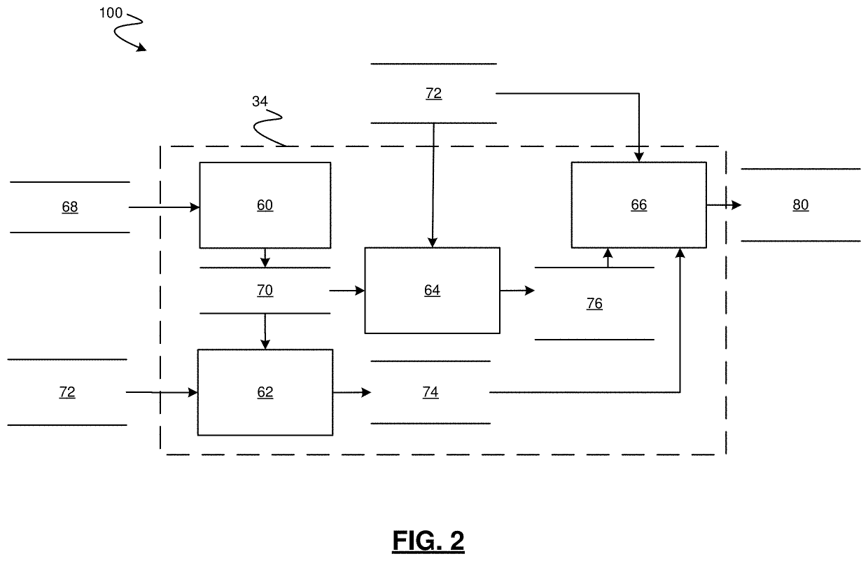

The communication system 36 is configured to wirelessly communicate information to and from other entities 48, such as but not limited to, other vehicles (“V2V” communication), infrastructure (“V2I” communication), networks (“V2N” communication), pedestrian (“V2P” communication), remote transportation systems, and/or user devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The controller 34 includes at least one processor 44 and a computer-readable storage device or media 46. The processor 44 may be any custom-made or commercially available processor, a central processing unit (CPU), a graphics processing unit (GPU), an application specific integrated circuit (ASIC) (e.g., a custom ASIC implementing a neural network), a field programmable gate array (FPGA), an auxiliary processor among several processors associated with the controller 34, a semiconductor-based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10. In various embodiments, the controller 34 is configured to implement instructions of the correction system 100 as discussed in detail below.

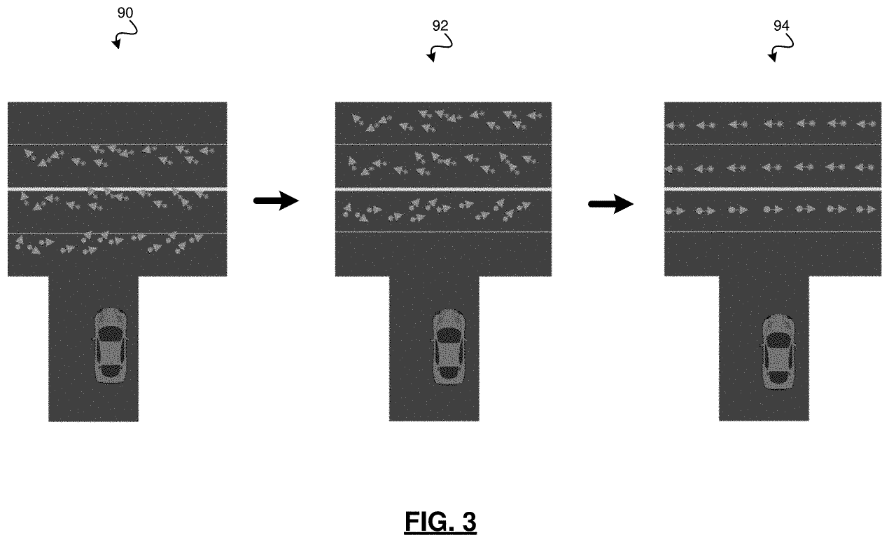

With reference now to FIG. 2 and with continued reference to FIG. 1, a dataflow diagram illustrates aspects of the correction system 100 in more detail. FIG. 3 is an illustration the data from the dataflow in accordance with various embodiments. As can be appreciated, the modules and sub-modules shown in FIG. 2 can be combined and/or further partitioned to similarly perform the functions described herein. Inputs to modules and sub-modules may be received from the sensor system 28, received from other control modules (not shown) associated with the vehicle 10, received from the communication system 36, and/or determined/modeled by other sub-modules (not shown) within the controller 34 of FIG. 1. The modules and sub-modules shown generally perform the functions of determining correction values that are applied to the sensor data and that are used in controlling the vehicle 10.

In various embodiments, the correction system 100 includes an enablement module 60, a range correction value determination module 62, a pitch/roll correction value determination module 64, and a correction application module 66.

The enablement module 60 receives as input sensor data 68. The sensor data 68 indicates conditions of the vehicle 10 and/or the environment of the vehicle 10. The sensor data 68 can include, but is not limited to, a vehicle location, vehicle speed, camera data, lidar data, radar data, etc.

The enablement module 60 processes the sensor data 68 to determine whether a correction value should be determined. The enablement module 60 sets an enablement status70 based on whether the correction value should/can be determined. For example, the correction value should be determined when the vehicle 10 is determined to be at or approaching an intersection with cross traffic. In another example, the correction value can be determined when the traffic flow of the cross traffic is sufficient for evaluation. As can be appreciated, the sensor data 68 may be processed for other enable criteria in various embodiments.

The range correction value determination module 62 receives as input object detection data 72 and the enablement status 70. The object detection data 72 includes positions and heading of objects detected as the cross traffic in the lanes generally in front of the vehicle 10. The object detection data 72 can be provided, for example, by other systems implementing one or more machine learning techniques.

When the enablement status 70 indicates that a correction value should/can be detected, the range correction value determination module 62 processes the object detection data 72 to determine a correction value (range bias) that best matches detections with lane centers in the longitudinal direction. For example, the range correction value determination module 62 uses a statistical approach to consider effects of uncertainty in range of the detected objects and develop one or more correction values 74.

In various embodiments, the range correction value determination module 62 computes the correction value(s) based on a likelihood function. For example, in various embodiments, the range correction value determination module 62 evaluates the likelihood function on a grid for a given observation window. In various embodiments, the likelihood function may be provided as:

l(Δ)=ΠⱼΣᵢ [symbol] (pⱼ−Δ|mᵢ, σₚ²) [symbol] (θⱼ|αᵢ, σ_{θ}²).

Where mᵢ represents longitudinal distance to lane center i , αᵢ represents the heading of lane i , pᵢ represents the longitudinal distance to detection i , θᵢ represents the heading of detection i, Δ represents the range bias in the window of interest, σₚ represents the standard deviation of detections in a longitudinal direction, σ_{θ} represents the standard deviation of the detection heading, and [symbol] (x|μ, σ²) represents PDF of normal distribution with mean μ and variance σ² at x.

In various embodiments, multiple observation windows can be used if a range bias varies in the field of view. In such case, the likelihood function is evaluated for a given observation window as:

lᵢ= [symbol] (Δᵢ) for Δᵢϵ[−ϵ,ϵ] where ϵ is maximum expected range error.

And spacing σₚ/(\sqrt{N}K), where K=2 and N is the number of samples.

Thereafter, the range correction value determination module 62 coarsely locates the N largest local maximas: \hat{Δ}ᵢ where [symbol] (\hat{Δ}ᵢ) is a local maximum, and removes small maximas. For example, the range correction value determination module 62 removes \hat{Δ}ᵢ

$$\frac{𝓁 ( {\hat{Δ}}_{i} )}{𝓁 ( {\hat{Δ}}_{j} )} < R ,$$

where R=100. The correction value determination module 62 then merges nearby maximas: If |\hat{Δ}ᵢ−\hat{Δ}ⱼ|<D Retain largest maxima or a weighted combination. If exactly one maxima \hat{Δ} is left, then the range correction value determination module 62 refines the value using an expectation maximization (EM) algorithm. For example, the following algorithm may be implemented:

$$E : P ( i \vert j , {Δ}_{t} ) = \frac{𝒩 ( {x}_{i j} \vert {Δ}_{t} , {σ}_{p}^{2} ) 𝒩 ( {φ}_{i j} \vert 0 , {σ}_{θ}^{2} )}{{Σ}_{j} 𝒩 ( {x}_{ij} \vert {Δ}_{t} , {σ}_{p}^{2} ) 𝒩 ( {φ}_{ij} \vert 0 , {σ}_{θ}^{2} )} , and \\ M : {Δ}_{t + 1} = \frac{{Σ}_{i} {Σ}_{j} {x}_{ij} P ( i \vert j , {Δ}_{t} )}{{Σ}_{i} {Σ}_{j} P ( i \vert j , {Δ}_{t} )}$$

Where xᵢⱼ=pᵢ−mⱼ and φᵢⱼ=ϕᵢⱼ=θᵢ−αᵢ.

If more than one maxima is left, the range correction value determination module performs the EM algorithm starting from each coarse maxima and generates a hypotheses for each refined \hat{Δ}ᵢ with probability given by a mixing weight. Alternatively, the range correction value determination module 62 selects a worst case offset that will minimize the distance to the nearest target and label the selected worst case as tentative. Once the value is determined it is provided as the range correction value 74.

The pitch/roll correction value determination module 64 receives as input the enablement status 70, and the object detection data 72. As before, the object detection data 72 includes positions and headings of objects detected as the cross traffic in the lanes generally in front of the vehicle 10. The object detection data 72 can be provided, for example, by other systems implementing one or more machine learning techniques.

The pitch/roll correction value determination module 64 processes the object detection data 72 to determine a correction value that best matches detections with lane centers in the longitudinal direction. For example, the pitch/roll correction value determination module 64 uses a similar statistical approach to consider effects of uncertainty in pitch and/or roll of the detected objects and develop one or more correction values 76.

In various embodiments, the pitch/roll correction value determination module 64 computes the correction value(s) 76 similarly based on a likelihood function. For example, in various embodiments, the pitch/roll correction value determination module 76 evaluates the likelihood function on a grid for a given observation window. The likelihood function may be provided as:

[symbol]

(Δθ, Δϕ)=ΠⱼΣᵢ [symbol] (dᵢⱼ|μᵢⱼ, σₚ²) [symbol] (θⱼ|αᵢ, σ_{θ}²),

dᵢⱼ=gᵢ(x_{w}(xⱼ, yⱼ|θ+Δθ, ϕ+Δϕ), y_{w}(xⱼ, yⱼ|θ+Δθ, ϕ+Δϕ)),

μᵢⱼ=hᵢ(x_{w}(xⱼ, yⱼ|θ+Δθ, ϕ+Δϕ), y_{w}(xⱼ, yⱼ|θ+Δθ, ϕ+Δϕ)),

Where x_{w}(xᵢ, yᵢ|ω, θ, ϕ, C) represents function mapping image coordinates to world x coordinates, and y_{w}(xᵢ, yᵢ|ω, θ, ϕ, C) represents function mapping image coordinates to world y coordinates. C represents additional camera calibration parameters, xᵢ, yᵢ represent coordinates in an image plane, ω, θ, ϕ represents current yaw, pitch and roll calibration parameters, Δθ, Δϕ represent the pitch and the roll orrection values,

$${g}_{i} ( x , y ) = \frac{{a}_{i} x + {b}_{i} y + {c}_{i}}{\sqrt{{a}_{i}^{2} + {b}_{i}^{2}}}$$

represents distance from (x, y) to straight line aᵢx+bᵢy+cᵢ=0, and

$${h}_{i} ( x , y ) = \frac{{a}_{i} ( - {b}_{i} x + {a}_{i} y ) - {b}_{i} {c}_{i}}{{a}_{i}^{2} + {b}_{i}^{2}}$$

represents corresponding y coordinate at a nearest point.

In various embodiments, the likelihood function is evaluated on a two dimensional grid ij as:

lᵢⱼ= [symbol] (Δθᵢ, Δϕⱼ) for Δθᵢϵ[−ϵ_{θ}, ϵ_{θ}] and Δϕⱼϵ[−ϵ_{ϕ}, ϵ_{ϕ}]

Where ϵ_{θ} and ϵ_{θ} are maximum expected pitch and rolls error angles. Spacing σₚ/(\sqrt{2N}K) where K=2 and N is the number of samples.

Thereafter, the pitch/roll correction value determination module 64 coarsely locates the N largest local maximas: Δ\hat{θ}ᵢ and Δ [symbol] . Where [symbol] (Δ\hat{θ}ᵢ, Δ [symbol] ) is a local maximum. The pitch/roll correction value determination module 64 removes small maximas. For example, if

$$\frac{𝓁 ( Δ \hat{{θ}_{l}} , Δ \hat{{φ}_{j}} )}{𝓁 ( Δ \hat{{θ}_{k}} , Δ \hat{{φ}_{l}} )} < R , W$$

where R=100.

The pitch/roll correction value determination module 64 then merges local maximas. For example, if |\hat{Δ}ᵢ−\hat{Δ}ᵢ|<D, retain the largest maxima or weighted combination. The pitch/roll correction value determination module 64 refines the maxima using gradient ascent and generates the hypotheses, for example, as discussed above with regard to the range correction value 74. The final remaining values Δ\hat{θ}ᵢ and Δ [symbol] are the pitch and the roll correction values 76.

The correction application module 66 receives the range correction values 74 the pitch and roll correction values 76, and the object detection data 72. The correction application module 66 and applies the correction values 74, 76 to the detected objects in the object detection data 72, to thereby correct the detected placement of the objects to be within the lane. For example, as shown in the exemplary illustration of FIG. 3, the object detection data 72 may first be received at 90, the range correction values are then applied at 92, and the pitch and the roll correction values applied at 94. Thus, the objects are then properly placed in a lane with the correct heading.

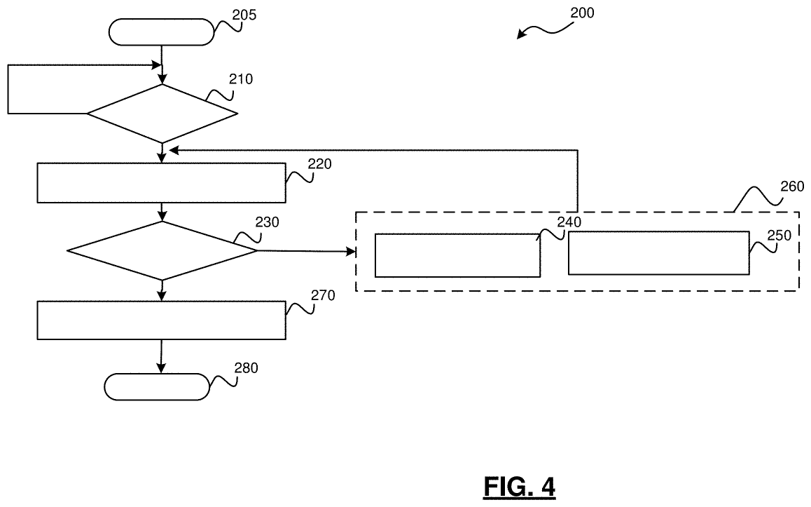

With reference now to FIG. 4, a flowchart illustrates a correction method 200 that may be performed by the correction system 100 (FIG. 1) in accordance with various embodiments. As can be appreciated in light of the disclosure, the order of operation within the method is not limited to the sequential execution as illustrated in FIG. 4 but may be performed in one or more varying orders as applicable and in accordance with the present disclosure. In various embodiments, the method 200 can be scheduled to run based on one or more predetermined events, and/or can run continuously during the operation of the vehicle 10.

In one example, the method may begin at 205. It is determined whether the enablement criteria are met at 210, for example if the vehicle 10 is currently at an intersection with cross traffic and if there is sufficient traffic flow. Once the enablement criteria are met at 210, the correction values 74, 76 are determined at 220-260. In various embodiments, the object detection data 72 may be divided into windows, depending on the amount of detections, and the date of each window is processed at 220-260. For example, the maxima of the posteriori estimate is computed using the likelihood functions and the expectation maximization (EM) algorithm at 220, for example, as discussed with regard to the exemplary equations. If a unique solution is not found at 230, a corrected detection hypothesis is generated at 260. The corrected detection hypothesis can be generated either based on multiple hypotheses at 240 or a worst case at 250. Thereafter, the method continues with receiving and processing the object detection data 72 from the intersection at 220. If a unique solution is found at 230, the corrections of range, pitch, and/or roll are applied to object detection data 72 at 270 and the method may end at 280.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of controlling a vehicle, comprising:
receiving, by a processor, object detection data that indicates a plurality of objects detected in an environment of the vehicle;
computing, by the processor, a correction value associated with at least one of range, roll, and pitch of the plurality of objects based on a likelihood function;
applying, by the processor, the correction value to the object detection data to obtain corrected object detection data; and
controlling, by the processor, the vehicle based on the corrected object detection data.

2. The method of claim 1, further comprising determining when the vehicle is at an intersection with cross traffic, and wherein the receiving, the computing, and the applying are performed when the vehicle is at the intersection.

3. The method of claim 1, further comprising determining when the cross traffic exceeds a threshold, and wherein the receiving, the computing, and the applying are performed when the cross traffic exceeds the threshold.

4. The method of claim 1, wherein the computing the correction value is further based on an expectation maximization algorithm.

5. The method of claim 4, wherein the computing the correction value comprises:
evaluating the likelihood function on a grid for a give observation window;
coarsely locating N largest local maximas from the grid;
removing any maximas less than a threshold;
merging nearby maximas; and
applying the expectation maximization algorithm when there is one maxima remaining.

6. The method of claim 5, wherein when there are more than one maxima remaining, selecting a worst case.

7. The method of claim 5, wherein when there are more than one maxima remaining, applying the expectation maximization algorithm to each coarse maxima and generating a hypotheses for each refined correction value with a probability given mixing a weight.

8. The method of claim 1, wherein the computing comprises computing the correction value for a window of data of the object detection data.

9. The method of claim 1, wherein the correction value is associated with range.

10. The method of claim 1, wherein the correction values is associated with pitch and roll.

11. A system for controlling a vehicle, comprising:
at least one sensor that senses objects within an environment of the vehicle; and
a controller configured to, by a processor, receive object detection data that indicates a plurality of objects detected in an environment of the vehicle, compute a correction value associated with at least one of range, roll, and pitch of the plurality of objects based on a likelihood function, apply the correction value to the object detection data to obtain corrected object detection data, and control the vehicle based on the corrected object detection data.

12. The system of claim 11, wherein the controller determines when the vehicle is at an intersection with cross traffic, and performs the receiving, the computing, and the applying when the vehicle is at the intersection.

13. The system of claim 11, wherein the controller determines when the cross traffic exceeds a threshold, and performs the receiving, the computing, and the applying when the cross traffic exceeds the threshold.

14. The system of claim 11, wherein the controller computes the correction value further based on an expectation maximization algorithm.

15. The system of claim 14, wherein the controller computes the correction value by:
evaluating the likelihood function on a grid for a give observation window;
coarsely locating N largest local maximas from the grid;
removing any maximas less than a threshold;
merging nearby maximas; and
applying the expectation maximization algorithm when there is one maxima remaining.

16. The system of claim 15, wherein when there are more than one maxima remaining, the controller selects a worst case as the correction value.

17. The system of claim 15, wherein when there are more than one maxima remaining, the controller applies the expectation maximization algorithm to each coarse maxima and generates a hypotheses for each refined correction value with a probability given mixing a weight for the correction value.

18. The system of claim 11, wherein the controller computes the correction value for a window of data of the object detection data.

19. The system of claim 11, wherein the correction value is associated with range.

20. The system of claim 11, wherein the correction values is associated with pitch and roll.
